(19) United States
(12) Patent Application Publication
(10) Pub. No.: US 2010/0061574 A1
(43) Pub. Date: Mar. 11, 2010

(54) AUDIO SYSTEM AND SOUND FIELD CONTROLLER

(75) Inventor: Stephen Halsall, Tonbridge Wells (GB)

Correspondence Address: Myers Andras Sherman LLP, 19900 MacArthur Blvd., Suite 1150, Irvine, CA, 92612, US

(73) Assignee: GP ACOUSTICS (UK) LIMITED, Maidstone (GB)

(21) Appl. No.: 11/919,445

(22) PCT Filed: Apr. 28, 2006
(86) PCT No.: PCT/GB2006/001580

§ 371 Date: Nov. 30, 2009

(30) Foreign Application Priority Data
Apr. 28, 2005 (GB) 0508616.0

(51) Int. Cl. H04R 5/02

(52) U.S. Cl. 381/300

(57) ABSTRACT

An audio system comprises three or more loudspeaker units and a source of four or more audio channels, each loudspeaker unit comprising a monopole loudspeaker and a dipole loudspeaker, or a pistonically driven diaphragm loudspeaker and a resonant panel loudspeaker. The system may be arranged such that, for any position relative to a listener at which a loudspeaker unit is situated in use, sounds emitted in response to signals carried by the audio channel for which the designated intended output position corresponds most closely to the position of that loudspeaker unit are emitted from the monopole loudspeaker or pistonically driven diaphragm loudspeaker of that unit. If a loudspeaker unit is not situated approximately at such a position, then sounds emitted in response to signals carried by that channel may instead may be emitted from the dipole loudspeaker or resonant panel loudspeaker of that loudspeaker unit.

### FIELD OF THE INVENTION

The present invention relates to audio systems.

### BACKGROUND OF THE INVENTION

A crucial aspect of home cinema systems is the nature and quality of the sound reproduction. An important feature of good home cinema sound reproduction is so-called “surround sound” or “ambient sound”, i.e. the illusion that the reproduced sound is emanating from all around the listener rather than from specific discrete sources (i.e. the loudspeakers). Conventionally, surround sound loudspeakers are positioned in a configuration around the viewer/listener so that the viewer/listener is physically surrounded by a large number of speakers.

At the present time, most digital versatile discs (DVDs) and super audio compact discs (SACDs) are produced using five, six or seven channels suitable for creating surround sound reproduction, for example, for home cinema applications. Particular versions of five, six and seven channel systems are the Dolby (trade mark) 5.1, 6.1 and 7.1 systems, for example. (In each case, the first digit refers to the number of main channels, and the second digit refers to an additional low frequency effects channel.)

In the five-channel system there is one centre loudspeaker that generally carries most of the dialogue, and may also carry parts of the soundtrack (music and sound effects) of the film. Front left and front right loudspeakers are connected to carry most of the soundtrack and may carry parts of the dialogue. A pair of surround sound loudspeakers is placed on either side of the viewer/listener (called, respectively, the left surround and right surround loudspeakers) to provide the surround sound and ambient effects, and a subwoofer can be used to reproduce the low and very low frequency effects. (The ambient and surround sound effects are also known as the diffuse effect as the sound appears not to emanate from one particular spatial point.)

In the six-channel system a centre back loudspeaker provides an additional surround sound channel output. In the seven-channel system, instead of a centre back loudspeaker there are left back and right back loudspeakers located behind the viewer/listener.

A disadvantage of these systems is that they require a large quantity of wiring and a large number of individual loudspeakers. This may not be aesthetically pleasing, may present practical difficulties in terms of positioning and space-consumption, and may require the purchaser of such systems to invest in special under-floor wiring, for example. In addition to the expense of the installation of the system there is the expense of purchasing a large number of individual speakers.

With the advent of multi-channel audio discs, the number of loudspeakers is likely to increase, thus causing further practicality problems and expense.

### BRIEF SUMMARY OF THE INVENTION

The present invention seeks to alleviate at least some of the problems of conventional surround sound reproduction installations, for example. The invention particularly seeks to avoid the need for a separate loudspeaker for each channel. The invention also seeks to avoid the need for positioning each loudspeaker at a particular location with respect to the listener/viewer according to the particular channel routed to that loudspeaker. Thus, the invention seeks to avoid at least some of the practicality problems of known systems. It is to be understood that the invention is not limited to SACD or home cinema applications, or to surround sound in general, although such applications will be particularly suited to the invention.

Accordingly, a first aspect of the present invention provides an audio system comprising three or more loudspeaker units and a source of four or more audio channels, wherein each loudspeaker unit comprises a monopole loudspeaker and a dipole loudspeaker.

Preferably, the monopole loudspeaker comprises a pistonically driven diaphragm loudspeaker. The dipole loudspeaker preferably comprises a resonant panel loudspeaker.

A second aspect of the invention accordingly provides an audio system comprising three or more loudspeaker units and a source of four or more audio channels, wherein each loudspeaker unit comprises a pistonically driven diaphragm loudspeaker and a resonant panel loudspeaker.

Preferably there are five or more audio channels and/or four or more loudspeaker units.

The resonant panel may be generally (especially substantially) planar. The plane of the resonant panel preferably lies generally in the same orientation as an axis along which the diaphragm is pistonically driven. More preferably, the axis along which the diaphragm is pistonically driven lies substantially in the plane of the resonant panel.

Advantageously, the number of loudspeaker units is less than the number of audio channels.

Preferably, the loudspeaker units of the system collectively are arranged to emit sounds in response to signals carried by the audio channels.

Each audio channel may have a respective designated intended output position relative to a listener. For example, the audio channels may comprise one or more (or all) of the following channels: front left; front centre; front right; left surround (side); right surround (side); back left; back centre; back right.

In preferred embodiments of the invention, any loudspeaker of any of the loudspeaker units may be arranged to emit sounds in response to signals carried by one or more of the audio channels. More preferably, any loudspeaker of any of the loudspeaker units may be arranged to emit sounds in response to signals carried by any of the audio channels. Advantageously, for each respective audio channel, the loudspeaker or loudspeakers from which sounds may be emitted in response to signals carried by that channel, may be selected at will.

Advantageously, in use, each loudspeaker unit may be situated at a respective position relative to a listener. The audio system preferably is arranged such that, for any position relative to a listener (e.g. to the front and left of the listener) at which a loudspeaker unit is situated in use, sounds emitted in response to signals carried by the audio channel for which the designated intended output position (e.g. the front left audio channel) corresponds most closely to the position of that loudspeaker unit are emitted from the monopole loudspeaker or pistonically driven diaphragm loudspeaker of that loudspeaker unit. For example, the audio system may be arranged such that, if a loudspeaker unit is situated at, or approximately at, a position relative to a listener that corresponds to a designated intended output position of an audio channel, then sounds emitted in response to signals carried by that channel are emitted from the monopole loudspeaker or pistonically driven diaphragm loudspeaker of that loudspeaker unit. Even more preferably, those sounds are emitted from the monopole loudspeaker only or pistonically driven diaphragm loudspeaker only of that loudspeaker unit.

If a loudspeaker unit of the audio system is not situated at, or not approximately at, a position relative to a listener that corresponds to a designated intended output position of a particular audio channel, then sounds emitted in response to signals carried by that channel preferably are not emitted from the monopole loudspeaker or pistonically driven diaphragm loudspeaker of that loudspeaker unit.

If a loudspeaker unit is not situated at, or not approximately at, a position relative to a listener that corresponds to a designated intended output position of a particular audio channel, then sounds emitted in response to signals carried by that channel preferably may. be selected to be emitted from the dipole loudspeaker or resonant panel loudspeaker of that loudspeaker unit.

Preferably, one or more of the audio channels is a surround sound or ambient sound channel, and the system is arranged such that sounds emitted in response to signals carried by such channel(s) are emitted from one or more of the dipole loudspeakers or resonant panel loudspeakers.

A third aspect of the invention provides an audio-visual system comprising an audio system according to the first or second aspect of the invention, and a visual display means.

A fourth aspect of the invention provides a method of installing an audio system or an audio-visual system according to the invention, comprising situating each loudspeaker unit at a respective position relative to a listener.

The method preferably comprises selecting, for each respective audio channel, the loudspeaker or loudspeakers from which sounds may be emitted in response to signals carried by that channel.

### BRIEF DESCRIPTION OF THE DRAWINGS

Some embodiments of the invention will now be described, by way of example, with reference to the accompanying drawings, of which:

FIG. 1 is a schematic illustration of a known loudspeaker configuration utilising five audio channels;

FIG. 2 is a schematic illustration of a known loudspeaker configuration utilising seven audio channels;

FIG. 3 is a schematic illustration of the relative positions and orientations of a resonant panel loudspeaker and a diaphragm loudspeaker of an embodiment of a loudspeaker unit used in the present invention;

FIG. 4 is a schematic illustration of a known audio-visual system in use;

FIG. 5 is a schematic illustration of an audio-visual system according to an aspect of the present invention in use; and

FIG. 6 is an exploded diagram of a preferred embodiment of a loudspeaker unit used in the present invention.

### DETAILED DESCRIPTION OF THE DRAWINGS

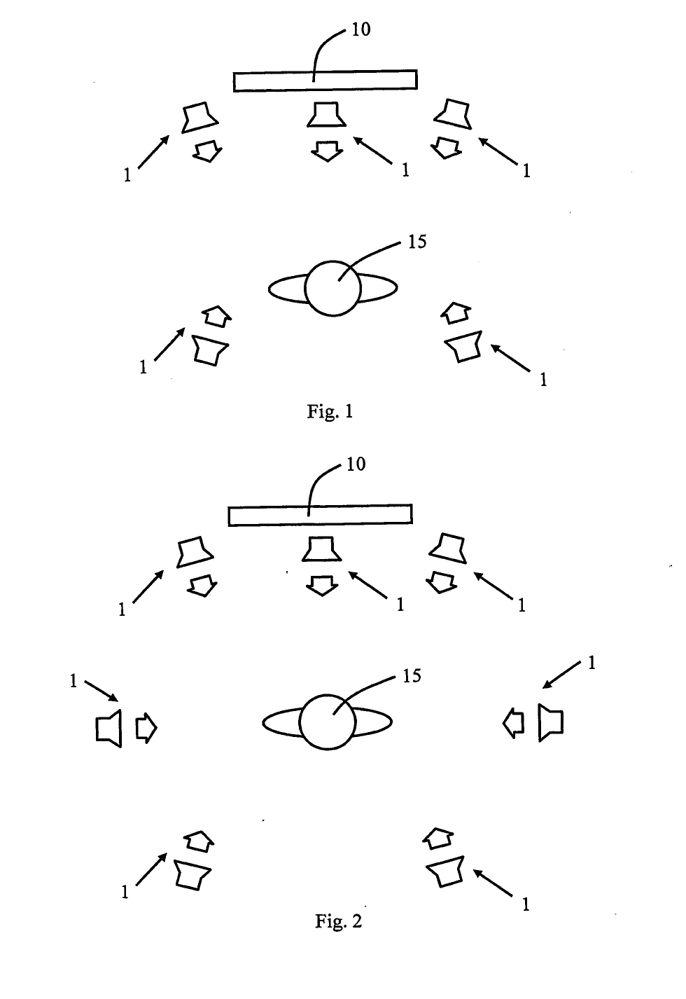

FIG. 1 shows a known 5.1 audio-visual system with five loudspeakers 1, arranged around the listener/viewer 15. A visual display means 10 (e.g. a television), is positioned in front of the listener/viewer. Each loudspeaker 1 is situated at a position relative to the listener/viewer that corresponds to a designated intended output position of an audio channel. Furthermore, each loudspeaker 1 is arranged to emit sounds in response to signals carried by the audio channel having the designated output position that corresponds to the position of the loudspeaker. Thus, the loudspeakers 1 are situated at the following positions relative to the listener/viewer: front centre; front left; front right; left surround; and right surround; and each loudspeaker emits sounds carried by the channel having the designated position corresponding to the position of that loudspeaker.

FIG. 2 shows a known 7.1 audio-visual system with 7 loudspeakers 1 arranged around the listener/viewer 15. In this system, two additional audio channels are used, namely back left (or rear left) and back right (or rear right). Consequently, two additional loudspeakers 1 are used, positioned at the back left and back right positions respectively.

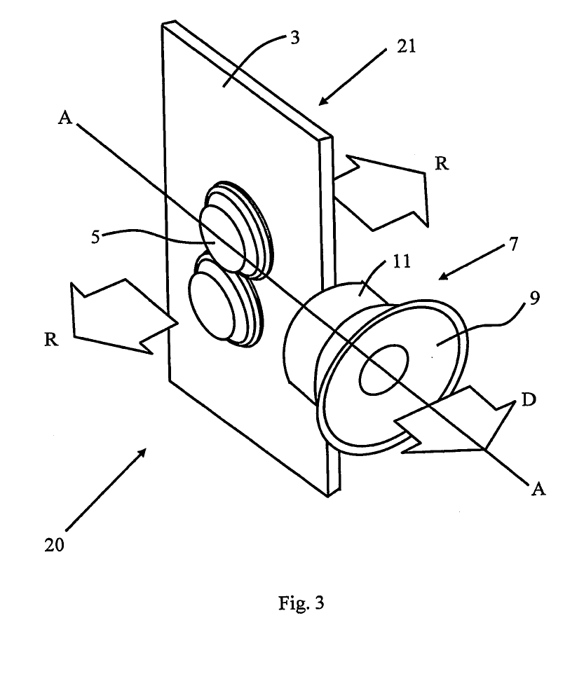

FIG. 3 shows, schematically, a preferred loudspeaker unit 20 as used in the present invention, comprising a resonant panel loudspeaker 21 and a diaphragm loudspeaker 7. The example resonant panel loudspeaker 21 comprises a generally planar resonant panel 3 having exciters. 5 attached thereto. The exciters 5 (two of which are shown, but the panel 3 may have just one exciter 5 or more than two exciters) are the drivers of the resonant panel loudspeaker 21, and cause the panel 3 to resonate and thereby to emit acoustic radiation. The exciter(s) 5 may generally comprise any type of transducer, for example electromagnetic (e.g. moving coil), piezoelectric, or electrostatic. The panel 3 itself may be formed from any of a wide variety of materials, for example polymeric materials and/or glass fibre materials and/or carbon fibre materials and/or cardboard (or the like). The panel 3 may comprise a single sheet of material, a plurality of layers (or other composite construction) and/or may include a core, for example of honeycomb or foam construction.

In the example shown in FIG. 3, the panel 3 is substantially planar (i.e. a generally thin and flat panel). This has the advantage that the acoustic radiation patterns which emanate from each major surface of the panel 3 may be substantially the same as each other (thereby, for example, enhancing the diffuse surround sound nature of the sound reproduction). Resonant panel loudspeakers are often termed “distributed-mode” loudspeakers (DMLs) because they generally function by exciting a plurality of vibrational modes distributed throughout the panel (the panel generally operating wholly in resonance). The resonant panel loudspeaker may, for example, be substantially as described in international patent application no. PCT/GB96/02145, the entire disclosure of which is incorporated herein by reference.

Referring to the pistonically driven diaphragm loudspeaker 7, the terms “pistonic loudspeaker” and “pistonically driven diaphragm loudspeaker” in this specification refer to a loudspeaker in which a diaphragm moves in a piston-like motion as a generally rigid whole for at least part of its operating frequency range (for example up to approximately 700 Hz). The exemplary pistonically driven diaphragm loudspeaker 7 comprises a generally conical diaphragm 9 and a driver 11 for the diaphragm 9. The driver 11 can be an electro-mechanical transducer, e.g. a moving coil transducer, but other types of drivers can also be used. The pistonically driven diaphragm loudspeaker 7 preferably provides coherent sound reproduction (whereas the resonant panel loudspeaker 21 preferably provides diffuse surround sound reproduction). Most preferably, the diaphragm loudspeaker 7 functions as a monopole acoustic source, and preferably the resonant panel loudspeaker 21 functions as a diffuse dipole acoustic source.

For loudspeaker units used in the present invention, the plane of the resonant panel loudspeaker 21 may, for example, be generally parallel to the axis A-A along which the diaphragm 9 is pistonically driven. Preferably, however, the plane of the resonant panel 3 and said axis are generally in line with each other (i.e. the axis preferably lies in generally the same plane as the panel). Preferably the plane of the panel 3 lies substantially in the same orientation as the axis along which the diaphragm 9 is pistonically driven. Consequently, the panel 3 and the axis preferably are either substantially parallel to each other or substantially in line with each other, i.e. the axis preferably lies in substantially the same plane as the panel. This is shown schematically in FIG. 3.

Preferably, the resonant panel loudspeaker 21 is located relative to the pistonically driven diaphragm loudspeaker 7 such that the emission of the acoustic radiation from the diaphragm loudspeaker 7 is substantially unimpeded by the resonant panel loudspeaker 21. Advantageously, the resonant panel loudspeaker 21 may be located above, below, to the side, or behind the diaphragm loudspeaker 7. Most preferably the resonant panel speaker 21 is located behind the diaphragm loudspeaker 7. In FIG. 3, the resonant panel 3 is located to the rear of the diaphragm loudspeaker 7, so that the directional acoustic output (as indicated by arrow D) of the diaphragm loudspeaker 7 is unimpeded by the resonant panel loudspeaker 21. The acoustic output of the resonant panel loudspeaker 21 is indicated by arrows R. As can be seen, the output of the resonant panel 3 is generally perpendicular to that of the diaphragm 9; it is diffuse and in the form of dipole with the “null” centred on the axis A-A of the diaphragm loudspeaker 7.

Preferably the resonant panel loudspeaker 21 is arranged to radiate sound from both opposite major surfaces of the panel 3 simultaneously. A loudspeaker unit 20 according to the present invention has the advantage that by orientating the plane of the resonant panel loudspeaker 21 so that it is in generally the same orientation as the axis of the pistonically driven diaphragm loudspeaker 7 the resonant panel loudspeaker 21 normally produces a generally “figure-of-eight” acoustic radiation pattern by radiating sound from both opposite major surfaces of the panel 3 with the “null” of the radiation pattern generally coincident with the axis of the diaphragm loudspeaker 7. Consequently, the use of a resonant panel loudspeaker 21 in this orientation produces the type of acoustic radiation pattern generally required of surround sound. Additionally, and most advantageously, resonant panel loudspeakers tend to produce diffuse acoustic radiation, which is ideal for creating ambient surround sound. These two characteristics in combination mean that the resonant panel loudspeaker 21 of the loudspeaker unit 20 according to the present invention generally provides an extremely effective surround sound loudspeaker system.

An enclosure for the loudspeaker unit 20 is omitted from FIG. 3 for clarity. Preferably, a loudspeaker unit 20 used in the present invention further comprises an enclosure in which the resonant panel loudspeaker 21 and the diaphragm loudspeaker 7 are housed.

Each loudspeaker unit 20 may comprise more than one pistonically driven diaphragm loudspeaker 7 and/or more than one resonant panel loudspeaker 21. For example, the function of the pistonic loudspeaker 7 may be carried out by a plurality of pistonic loudspeakers (e.g. with each such loudspeaker dedicated to a respective frequency range). The pistonically driven diaphragm loudspeaker 7 may, for example, comprise a compound loudspeaker of the type disclosed in U.S. Pat. No. 5,548,657, the entire disclosure of which is incorporated herein by reference.

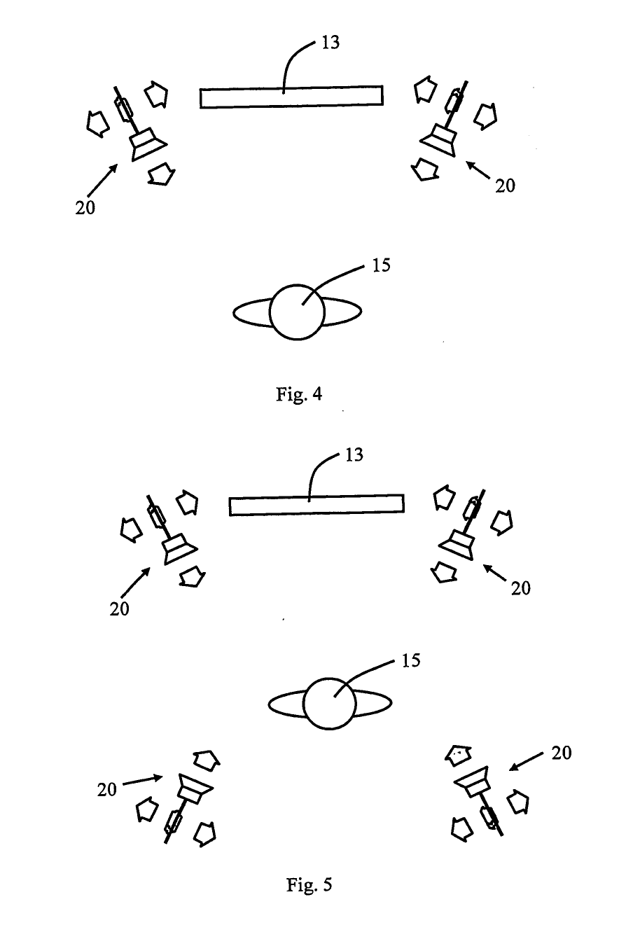

FIG. 4 shows, schematically, a known use of two loudspeaker units 20 by a listener (or viewer of a home cinema system), as disclosed in European Patent Application EP 1408717, the entire disclosure of which is incorporated herein by reference. The known system comprises a television set 13 (or other visual display means) and two loudspeaker units such as the loudspeaker units 20 shown in FIG. 3. The loudspeaker units 20 are located on either side of the television 13 and orientated such that their diaphragm loudspeakers 7 are directed towards the listener/viewer 15. Each of the two diaphragm loudspeakers 7 of the two units 20 emits imaged stereophonic acoustic radiation and the two resonant panel loudspeakers 21 emit diffuse (non-imaged) surround sound acoustic radiation.

FIG. 5 shows a schematic plan view of an example of an audio-visual system according to the present invention. The system as illustrated comprises a visual display means 13 (e.g. a television) and four loudspeaker units 20, each of which comprises a monopole pistonically driven diaphragm loudspeaker 7 and a dipole resonant panel loudspeaker 21. The system may, for example, be used with a seven channel audio system (e.g. Dolby™ 7.1), e.g. as follows. Two of the loudspeaker units 20 may be situated in front of the listener/viewer on either side of the display means 13 at positions front left and front right. The other two loudspeaker units 20 may be situated behind and/or to the side of the listener/viewer, on either side of the listener viewer; that is, the other two loudspeaker units may be situated at positions back left and back right, or at positions surround left (or side left) and surround right (or side right), for example.

The system shown in FIG. 5 may, for example, be arranged such that the audio channels are allocated to loudspeakers of the system as follows. Front centre and front left audio channels may be allocated to the monopole diaphragm loudspeaker of the loudspeaker unit situated to the front and left of the listener/viewer. Front centre and front right audio channels may be allocated to the monopole diaphragm loudspeaker of the loudspeaker unit situated to the front and right of the listener/viewer. The back left audio channel may be allocated to the monopole diaphragm loudspeaker of the loudspeaker unit situated behind and/or to the side of the listener/viewer on the left. The back right audio channel may be allocated to the monopole diaphragm loudspeaker of the loudspeaker unit situated behind and/or to the side of the listener/viewer on the right. The left surround/ambient (or side left) audio channel may be allocated to the dipole resonant panel loudspeakers of the two loudspeaker units situated on the left side of the listener/viewer (i.e. the left front and the left side/back). The right surround/ ambient (or side right) audio channel may be allocated to the dipole resonant panel loudspeakers of the two loudspeaker units situated on the right side of the listener/viewer (i.e. the right front and the right side/back).

It will be understood from the above described example of audio channel allocations according to loudspeaker unit position and according to loudspeaker type, that an audio system or an audio-visual system according to the invention preferably is arranged such that, for any position relative to a listener at which a loudspeaker unit is situated in use, sounds emitted in response to signals carried by the audio channel for which the designated intended output position (e.g. front left, front right, etc.) corresponds most closely to the position of that loudspeaker unit preferably are emitted from the monopole loudspeaker or pistonically driven diaphragm loudspeaker of that loudspeaker unit. For example, the audio system may be arranged such that, if a loudspeaker unit is situated at, or approximately at, a position relative to a listener that corresponds to a designated intended output position of an audio channel (e.g. front left), then sounds emitted in response to signals carried by that channel (e.g. front left) are emitted from the monopole loudspeaker or pistonically driven diaphragm loudspeaker of that loudspeaker unit. Even more preferably, those sounds are emitted from the monopole loudspeaker only or pistonically driven diaphragm loudspeaker only of that loudspeaker unit.

However, if a loudspeaker unit of the audio system is not situated at, or not approximately at, a position relative to a listener that corresponds to a designated intended output position of a particular audio channel (e.g. the loudspeaker unit is situated front left, whereas the particular audio channel being considered is the left side surround/ambient channel), then sounds emitted in response to signals carried by that channel preferably are not emitted from the monopole loudspeaker or pistonically driven diaphragm loudspeaker of that loudspeaker unit. Instead, sounds emitted in response to signals carried by that channel (e.g. the left side surround/ambient channel) may be allocated such that they are emitted from the dipole/resonant panel loudspeaker of that loudspeaker unit (positioned front left).

Preferably, the rear/side audio channels are allocated to the dipole/resonant panel loudspeakers situated at the front and at the side/rear and also allocated to the monopole/diaphragm loudspeakers situated at the rear/side. The balance of the front/rear channels between loudspeakers preferably will be varied depending upon the positions of the loudspeaker units. In particular, if the rear/side loudspeaker units are at the side, then the side channels preferably are allocated to the monopole/diaphragm loudspeakers and the rear channels are allocated to the dipole/resonant panel loudspeakers. Alternatively, if the rear/side loudspeaker units are behind the listener, then the side channels preferably are allocated to the dipole/resonant panel loudspeakers and the rear channels are allocated to the monopole/diaphragm loudspeakers. Such allocations, and all of the audio channel allocations described in this specification, preferably may be proportional, that is a proportion of a particular channel may be allocated to a particular loudspeaker, and another proportion of the channel may be allocated to one or more other loudspeakers. Depending upon the desired balance and room positioning, the dipole/resonant panel loudspeakers at the front may have some side signal applied to them. The dipole/resonant panel loudspeakers preferably are used to provide an ambient effect for the surround signals and the rear monopole/diaphragm loudspeakers preferably are used for the “sound effects” signals.

The listener/viewer preferably can allocate the audio channels to the various loudspeakers of the loudspeaker units with at least partial freedom, but more preferably with complete freedom, at will. Alternatively, however, the system may itself allocate (e.g. under computer control without direct intervention by the listener/viewer) the audio channels to the various loudspeakers of the loudspeaker units. Such allocation (whether by the listener/viewer, or by the system itself) may, for example, be an “active” allocation,.that is, the allocations or distributions of channels between the loudspeakers may be changed (e.g. continuously or periodically) during the operation of the system. Alternatively, the allocations may be fixed.

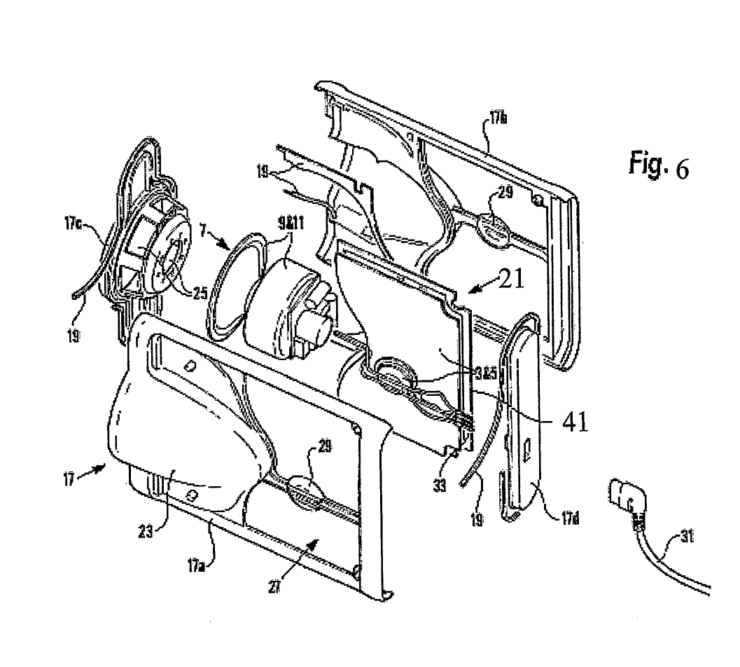

FIG. 6 is an exploded diagram of a preferred embodiment of a loudspeaker unit according to the present invention. In this embodiment, the loudspeaker unit comprises a resonant panel loudspeaker 21 comprising a resonant panel 3 with an exciter 5 (in the form of an electro-mechanical transducer) attached thereto, and a pistonically driven diaphragm loudspeaker 7. The diaphragm loudspeaker 7 comprises a diaphragm 9 and a driver 11. The pistonically driven diaphragm loudspeaker 7 can, for example, be a compound loudspeaker of the type disclosed in U.S. Pat. No. 5,548,657. The compound diaphragm loudspeaker 7 comprises a low frequency part having the generally conical diaphragm 9 shown, and a high frequency part having a generally dome-shaped diaphragm (not shown) located in or adjacent to the neck of the conical diaphragm 9.

The loudspeaker unit shown in FIG. 6 also includes an enclosure 17 in which the resonant panel loudspeaker 21 and the diaphragm loudspeaker 7 are housed. The enclosure 17 comprises a plurality of sections, or panels, assembled together around the loudspeakers 21 and 7. In the example shown, the enclosure 17 comprises two side panels 17a and 17b, a front panel 17c, and a rear panel 17d. The various panels have gaskets (or other seals) 19 situated between them, to seal the enclosure. The gaskets (or other seals) 19 may, for example, be formed from polymeric foam or other polymeric sealing material. The resonant panel 3 is retained in place in the enclosure 17 by means of an adhesive pad 41 (and/or by means of adhesive tape, not shown).

As can clearly be seen in FIG. 6, the enclosure 17 comprises two main parts. A first part 23 of the enclosure 17 encloses (preferably fully encloses) the pistonically driven diaphragm loudspeaker 7 other than by the front panel 17c that includes openings 25 through which the forwardly directed acoustic radiation emitted by the diaphragm loudspeaker 7. is arranged to propagate. A second part 27 retains the resonant panel loudspeaker 21 but is open on opposite major sides thereof adjacent to the opposite major sides of the resonant panel 3, to allow the laterally directed acoustic radiation emitted by the resonant panel loudspeaker 21 to propagate substantially freely from the unit. The (or each) exciter 5 is protected by means of a small enclosure element 29 located within the open sides of the second part 27 of the enclosure. A lead 31 is connectable to both loudspeakers 21, 7 of the unit 14 via terminal pins 33.

The present invention has been described in considerable detail with reference to certain preferred versions thereof; however, other versions are possible. Therefore, the spirit and scope of the appended claims should not be limited to the description of the preferred versions contained herein.

1.-28. (canceled)

29. An audio system, comprising:
three or more loudspeaker units, each loudspeaker unit comprising a monopole loudspeaker functioning as a coherent sound source, and a dipole loudspeaker functioning as a diffuse acoustic source; and
a source of four or more audio channels for feeding the loudspeaker units, each audio channel having an intended output position relative to a listener,
wherein the system is arranged such that, if one of the loudspeaker units is not at, or approximately at, a position relative to the listener that corresponds to the intended output position for a particular audio channel being fed to that loudspeaker unit, then sounds emitted in response to signals carried by the particular audio channel are emitted from the dipole loudspeaker of that loudspeaker unit.

30. The audio system according to claim 29, wherein for any position relative to a listener at which selected one of the loudspeaker units is situated in use, sounds emitted in response to signals carried by an audio channel for which the intended output position corresponds closely to the position of said one of the loudspeaker units are emitted from the monopole loudspeaker of that loudspeaker unit.

31. The audio system according to claim 29, wherein the monopole loudspeaker comprises a pistonically driven diaphragm loudspeaker.

32. The audio system according to claim 29, wherein the dipole loudspeaker comprises a resonant panel loudspeaker.

33. The audio system according claim 32, wherein each resonant panel loudspeaker is generally planar.

34. The audio system according to claim 33, wherein the plane of the resonant panel lies generally in the same orientation as an axis along which the diaphragm is pistonically driven.

35. The audio system according to claim 34, wherein the axis along which the diaphragm is pistonically driven lies substantially in the plane of the resonant panel.

36. The audio system according to claim 29, wherein the number of loudspeaker units is less than the number of audio channels.

37. The audio system according to claim 29, wherein at least one of the audio channels is a surround sound or ambient sound channel, and the system is arranged such that sounds emitted in response to signals carried by the at least one surround sound or ambient sound channel are emitted from one or more of the dipole loudspeakers.

38. The audio system according to claim 29, wherein there are five or more audio channels.

39. The audio system according to claim 29, wherein there are four or more loudspeaker units.

40. An audio-visual system comprising:
visual audio means; and
an audio system, comprising:
three or more loudspeaker units, each loudspeaker unit comprising a monopole loudspeaker functioning as a coherent sound source, and a dipole loudspeaker functioning as a diffuse acoustic source; and
a source of four or more audio channels for feeding the loudspeaker units, each audio channel having an intended output position relative to a listener,
wherein the system is arranged such that, if one of the loudspeaker units is not at, or approximately at, a position relative to the listener that corresponds to the intended output position for a particular audio channel being fed to that loudspeaker unit, then sounds emitted in response to signals carried by the particular audio channel are emitted from the dipole loudspeaker of that loudspeaker unit.

41. A method of installing an audio system or an audio-visual system comprising three or more loudspeaker units, each loudspeaker unit comprising a monopole loudspeaker functioning as a coherent sound source, and a dipole loudspeaker functioning as a diffuse acoustic source, and a source of four or more audio channels, each audio channel having an intended output position relative to a listener, the method comprising:
determining a position relative to a listener for each loudspeaker unit; and
allocating each of said audio channels to a loudspeaker, while ensuring that an audio channel allocated to a loudspeaker of a loudspeaker unit which has a position which is not at, or approximately at, the intended output position of the audio channel is allocated to a said dipole loudspeaker.

42. The method according to claim 41, wherein an audio channel allocated to a loudspeaker of a loudspeaker unit which has a position closely corresponding to the intended output position of the audio channel, is allocated to a said monopole loudspeaker.
